(19) United States
(12) Patent Application Publication
(10) Pub. No.: US 2024/0043202 A1
(43) Pub. Date: Feb. 8, 2024

(54) A MODULAR LOGISTICS SYSTEM

(71) Applicant: Feasibility Pty Ltd, Boorooma NSW (AU)

(72) Inventor: Benjamin John Smith, Booroma NSW (AU)

(73) Assignee: Feasibility Pty Ltd, Boorooma NSW (AU)

(21) Appl. No.: 18/258,756

(22) PCT Filed: Dec. 21, 2021
(86) PCT No.: PCT/AU2021/051528

§ 371 Date: Jun. 21, 2023

(30) Foreign Application Priority Data
Dec. 21, 2020 (AU) 2020904759

(51) Int. Cl. B65D 88/00; B65G 69/00; B65D 88/52; B65D 88/74; B65D 88/54; B60P 1/64; E04H 7/30

(52) U.S. Cl. CPC B65D 88/005; B65G 69/00; B65D 88/526; B65D 88/741; B65D 88/745; B65D 88/542; B65D 88/546; B60P 1/6418; E04H 7/30; B65G 2207/30; B65D 2588/746; B65D 2588/12; A01F 25/183

(57) ABSTRACT

A modular logistics system (10) including:
a container (12) having a top (14), a base (16), side walls (18) and end walls (20); and
a storage frame (23) housed within the container (12) in an operationally ready state, wherein in a first configuration the side walls (18) and end walls (20) are fixed to form an enclosure around the storage frame (23) for transport of the storage system (10), and in a second configuration the end panels (20) are removable to allow extension of the storage frame (23), and at least a portion of one of the side walls (18) is removable to provide access to the storage frame (23) during use, so that the container (12) and the storage frame (23) are transported and installed as a single unit.

### FIELD

The present invention relates to a storage and logistics framework system, and in particular, to a modular storage and logistics framework system for the transportation, management and storage of grain, fruit and other produce or the like, such as ore, concentrate, and other liquids.

### BACKGROUND

In the agricultural, fertiliser and pest-control industries, as well as industries where bulk solids are managed, it is necessary to store, treat and move large amounts of material over long periods of time and over long distances.

At larger receival and management sites, current storage facilities provide fixed, permanent, and semi-permanent means for storing, treating, and managing bulk material such as grain, fertiliser, seed, herbicides, soil conditioning mediums and the like. Typically, the storages are installed at centralised receival and management sites using metal and/or concrete silos, sheds, and tanks. Storage facilities may also be of a more open nature and covered in tarpaulin type materials. Plant and equipment is generally fixed and consists of receival hoppers, sampling and testing facilities, weighing equipment, elevators, storage areas, conveyors, augers, and other management equipment. Storage piles/facilities can reach heights of up to one hundred metres and have the capacity to store many hundreds of thousands of tonnes of material. Storage facilities may also be many hundreds of metres in length to accommodate the volumetric storage capacity required. At these larger sites, agricultural materials may be in-loaded or out-loaded onto road, rail, aircraft or ocean-going vessels or fluvial watercraft, such as barges.

On farm and at smaller receival and management sites, there is also a combination of fixed, semi-mobile and mobile means for storing, treating, and managing bulk material such as grain, fertiliser, seed, herbicides, soil conditioning mediums and the like. Typically, the storage facilities use metal and/or concrete silos, sheds, and tanks. Storage facilities may also be of a more temporary nature and be made of plastic to form a storage bag or cell or be of a more open nature and covered in tarpaulin type materials. Storage facilities can also be of a bin type arrangement mounted on wheels and have the ability to be quickly moved from one location to another. Storage facilities in smaller receival sites and on farms typically reach heights of up to fifty metres and have the capacity to store many thousands of tonnes of material. Storages that are mobile or temporary in nature, such as temporary bags and smaller mobile bins, may typically store relatively small amounts to accommodate the reduced volumetric storage capacity required.

The storage facilites are required to be installed and operated in and accommodate various terrain, climatic conditions, and operating configurations.

At present, permanent and semi-permanent storages are constructed on site. Parts are shipped in via train or truck and assembled on site. This is usually carried out manually and involves substantial amounts of manual handling, physical work and working at heights. The construction is time consuming and costly, particularly in remote areas where personnel must be transported to and from the site and accommodated. Additionally, the storage facilities are typically open to air, and are exposed to heat, dust, rain, hail, wind, and other weather elements thus causing deterioration of the storage structure itself. The openness to air also makes the storage facilities susceptible to pests, vermin, and loss of goods from fires/combustion.

In larger and more permanent storage situations, mechanical and electrical components may include conveyor belting, conveyor idlers, rubber elevator belting, elevator buckets, augers, chain conveyors, and other means of transporting and managing the flow of materials around site.

On farms, simpler means typically exist for the movement and management of materials and may typically include smaller conveyors, augers, and lower-capacity transport devices.

Temporary and mobile storages are currently also susceptible to damage and degradation of the material being stored. Temporary storages, in particular temporary storage bags, are particularly prone to physical damage being constructed of a light weight and single use plastic film material. Generally, the movement of solid goods from farms to temporary or central storages are susceptible to bottlenecking of the logistics, which cannot be easily planned in advance due to the changing demands on the logistics supply chain caused by seasonal production variations. The bottlenecking typically takes the form of extraordinary wait-times for trucks, extending into dozens of hours for each trip. Additionally, the need for tracking, tracing, and segregating trade products has increasingly emerged due to increased consumer demand for traceability of goods to the site of raw material production.

In colder climates, storage facilites are subject to snow loads, ice build-up and the freezing of components. This can lead to premature wear; failure of components and deterioration of the material being stored and managed.

Accordingly, there is a need for a better storage system.

### OBJECT OF THE INVENTION

It is the object of the present invention to substantially overcome or ameliorate one or more of the disadvantages of the prior art, or to at least provide a useful alternative.

### SUMMARY OF THE INVENTION

In a first aspect the present invention provides a modular logistics system including:
a container having a top, a base, side walls and end walls; and
a storage frame housed within the container in an operationally ready state, wherein in a first configuration the side walls and end walls are fixed to form an enclosure around the storage frame for transport of the storage system, and in a second configuration the end panels are removable to allow extension of the storage frame, and at least a portion of one of the side walls is removable to provide access to the storage frame during use, so that the container and the storage frame are transported and installed as a single unit.

In one embodiment, the removable side wall is pivotably attached at the base and configured to open outwardly until generally parallel with the base to form a platform or walkway.

In another embodiment the removable panel may be slidably attached at or within the base of the container and configured to extend in a parallel manner from within the container to form the platform or walkway. Grating and handrails may be added for additional safety.

In a preferred embodiment, the modular storage system includes a plurality of storage frames, each frame being housed in its respective container in an operationally ready state, and each modular storage system being connectable to an adjacent modular storage system to form a continuous run.

In one embodiment, a plurality of storage modules and frames may be housed in a single container in an operationally ready state to allow for the transport, installation and use of more than one storage line in total. Preferably, the storage frames are housed in a vertical configuration.

The container may be a standard 20 ft (5885 mm) or 40 ft (12,033 mm) shipping container. Alternatively, the container may be of any other suitable size to fit the storage frame or application.

Preferably, the modular storage systems may be connectable in multiple configurations including a horizontally straight and level configuration suitable for level terrain, a vertical and/or horizontal configuration to negotiate undulating terrain, or a horizontally straight and curved configuration to negotiate turns and the like. For example, a configuration may include successive storage systems connected in a straight vertical and/or horizontal profile and successive storage systems connected to form a profile in any plane.

The container may be used to store, manage, transport, or treat any material. This may include liquids, solids, gases, semi-solids, particles, or other bulk solids that may flow.

In one embodiment, the walls of the container itself may provide suitable storage for material within the container.

In one embodiment, the container may be used in any vertical, horizontal, or in any other plane or relative orientation.

In another embodiment, the container may house an inner storage structure made from a metal such as steel, plastic, polymer, fabric, textile, or other suitable form of material suitable for the intended materials being stored. In one embodiment the inner storage structure may conform to the outer walls of the container or may be of a different internal volume and volumetric shape or dimension to that of the container itself. In another embodiment, the inner storage structure may be rigid, flexible or a combination of the two.

In one embodiment, the container and/or inner storage structure within may be accessed by at least one cover or opening in the roof, any side or end wall of the container. In one embodiment this cover may be slidably attached and operated. In another embodiment, the cover(s) may be pivotably attached. In another embodiment, the cover(s) may be operable by rolling. In another embodiment, the cover may be screwed into and away from the container or inner storage structure.

In one embodiment, the inner storage structure may have access provided separate to that of the access means to the container.

In another embodiment, at any access point to the container or the inner storage structure, a protective hood or shroud may be provided for the purposes of securing and protecting material transfer from contaminants, weather ingress, material loss or for the control of dust.

In one embodiment, loading of material into the container may be effected by mechanical means. In another embodiment, loading of material into the container may be effected by gravitational means, or in any combination of both mechanical and gravitational means.

In a preferred embodiment, the container and any inner storage structure is designed and provided in such a manner as to be water and air tight during normal use and conditions. In another embodiment, the container and any inner storage structure may be designed and provided in such a manner as to be open to the elements or atmosphere within the container.

In a preferred embodiment, any inner storage structure is fixed in place within the container. In another embodiment, any inner storage structure may be removable from the container either partly, or wholly, and interchangeable with other storage structures.

In a preferred embodiment, the container may be fitted with ventilation devices to allow gasses, dust, or excessive heat to be dissipated to outside the container, but prevent the ingress of moisture, dust, pests, or other unwanted contaminants.

In a preferred embodiment, the container may be unloaded via gravitational means via chutes, outlets and other openings located under the container or storage unit.

In a preferred embodiment, the container may be unloaded via a dedicated unloading chute, channel, conduit, or pipe connecting successive out loading areas of storage modules.

In a preferred embodiment, the flow rate of material into and/or from within the container or individual storage modules may be controlled by valves, slides, or other control mechanisms.

In a preferred embodiment, the container may be unloaded via means using an auger, conveyor, compressed air, suction, or other appropriate mechanical or electro-mechanical means. In another embodiment, the container may be unloaded via multiple numbers of and combinations of, augers, conveyors, compressed air systems, suction devices, or other appropriate mechanical or electro-mechanical means.

In a preferred embodiment, the container may be unloaded via tipping or rotating the container or individual storage modules at any angle other than upright to facilitate the flow of material from the container and any storage modules within.

In a preferred embodiment, the container, and any storage modules within the container, may be unloaded from above, alongside, or underneath any surface of the container by an appropriate means for the purpose.

In a preferred embodiment, the contents of the container or the storage modules housed within the container, is provided with the means necessary to be able to be weighed.

In a preferred embodiment, the container or storage modules may be transported by any capable truck, trailer, train, ship, or boat capable of carrying shipping containers.

In one embodiment, the access and platform/walkway may be covered by a roof or similar protective structure. The removable panel may be pivotably attached at the top or upper portion of the container and configured to open outwardly until at an angle or parallel with the base to form a roof or cover. The access means may also include a removable panel slidably attached at or within a top portion of a side panel of the container. The panel being slidable in a parallel manner from within the container to form the roof or cover.

In another embodiment, the access means includes a platform or walkway within and/or external to the shipping container.

Preferably, the container is fitted with fixtures and features such as chains, hooks, slings, lifting points, fork tine openings and conventional container securing mechanisms to facilitate transport using conventional transport means, such as train or truck, and other equipment suitable to shipping containers.

Preferably, the storage system includes all required piped services housed within the container. In one embodiment this may include compressed air lines and/or hoses; fresh, fire and waste-water reticulation pipes and hoses. In another embodiment this may include lines for the transportation and reticulation of liquid pesticides, fertilisers, or gasses.

Preferably, the storage system includes a fire protection system fitted within the container. In one embodiment, this may be a water deluge-type system reticulated through, within or along the container, and to successive containers. In another embodiment, this may be a reticulated gas or other flame suppressant-type mixture, substance, or material. In another embodiment, this may be of an oxygen-displacing type gaseous system.

Preferably, the storage system includes insulated electrical conductors, cabling and other associated power reticulation devices fitted within, or to, the container.

Preferably, the storage system includes lighting systems within the container to illuminate the interior and/or exterior of the container.

Preferably, the container includes means for the sampling of material stored within the container, from a position inside and/or outside the container. This may be effected by sample tube, sample collection probe or other means so as to sample the interior contents without unduly disrupting the contents or allowing outside contaminants to enter the container.

Preferably, the container includes attachment means for connecting to an adjacent container to form a continuous storage run. The attachment means may include a mounting plate to seal the containers from the outside environment. The attachment means also includes an optional mounting plate to connect two or more successive containers together in order to increase the vertical height of the containers. The attachment means may also include provision for the connection between successive containers, of the storage frame, itself, any walkway or platform within each container and any services, power, reticulated medium or communications within the container and to and from successive containers.

Preferably, the container is configured to securely attach to ground footings. In one embodiment, ground footings may consist of a concrete footing with appropriate mechanisms to secure the container in place. In another embodiment, the footings may consist of a purely steel structure embedded securely into the ground. In another embodiment, the footings may be of a combination of concrete and steel, or any other material deemed appropriate.

In another embodiment, the storage system includes a skid plate for mounting directly onto the ground. The skid plate is formed from a suitable material that allows the container's ground contact foot print to be enlarged or altered than otherwise provided by the ground contact points of the container itself. The skid plate facilitates movement of the storage modules along the ground without the need for lifting and transporting by specialised equipment.

In another embodiment, adjustment mechanisms are fitted to the container to independently adjust the height, position, or orientation of the container relative to ground. Preferably, the container includes telescopic legs adjustable in length to retract within the container and extend outwardly from the container. Still preferably, the container includes locking or other securing means to secure the legs in a selected position. The locking means can include a bolt, pin, hydraulic, pneumatic, screw or any other suitable mechanism.

In another embodiment, the container is mountable to another supporting frame or structure secured in the ground. The frame or structure may be formed of steel, concrete, or other suitable material. The supporting frame is configured to raise the storage system above the terrain. The supporting frame is adjustable in height independently at each support leg.

In another embodiment, the container may be fitted with suitable enclosure material or panelling to one or more walls, top, and base in order to protect the storage frame from the outside environment. The panelling may include insulation to attenuate noise and vibration and/or control the temperature within the container. The panelling may also include the steel wall material already found in shipping containers. The panelling may also include insulated panelling to protect provide a controlled thermal environment inside the storage.

In another embodiment, the container may be fitted with only partial walls and enclosures that provide access to and air flow around the structure. In another embodiment, all walls and enclosures are removed to provide access to and air flow around the structure.

In another embodiment, the container may include means disposed on or within the container to generate electricity. This means may include solar panelling, other photovoltaic surfaces and devices, wind turbines, or mechanical or electromagnetic devices configured to generate power from the movement of the storage or flow of material.

In another embodiment, the container may include additional structural members configured to support substantial loading, for example due to land and/or backfill material, to enable the storage system to be buried or installed in a sub-terranean position. Additionally, additional structural members may be installed for strengthening the container for use in other loading conditions or situation that requires stiffening or strengthening of the container above that normally provided by the container itself. Preferably, the structural members include deterioration control protecting mechanisms to prevent corrosion, rusting or other deformation of members and components. Structural members may include cross-bracing in a vertical, horizontal, or other angled configuration and located in any plane within the container.

In another embodiment, the container may be constructed such that it may be installed on the surface and back-filled alongside and over the top of the container for environmental or other structure and/or stability reasons.

In one embodiment, the container may be fitted with a ventilation system to provide fresh air into the container, or vent fouled air from the container. In another embodiment, the container may be fitted with temperature or atmospheric control systems and devices to control the internal environment within the container.

In one embodiment, the container may be fitted with a ventilation system to provide fresh air into the storage cell within the container, or to vent warm air from the storage cell within the container.

In one embodiment, the container may be stacked more than a single container in height.

In another embodiment, the containers may also be joined laterally, along the longer side or shorter end, to form more than one storage system in a parallel or sub-parallel fashion in any, or multiple lateral direction(s).

In another embodiment, the containers may also be provided with access and egress means vertically or horizontally from the container. This may be by stairs, ladder, walkway, ramp, or other access means.

In another embodiment, the containers may be provided with a means of tracking the geolocational position of the container by electronic or visual means.

Preferably, the storage system includes communications conductors, cabling, transmitters, receivers, and other associated communications devices fitted within, or to, the container.

Preferably, the storage system includes data storage and manipulation devices fitted within, or to, the container.

Preferably, the storage system includes data storage and manipulation devices fitted within, or to, the container such that an integrated mesh of inter-connected data points and containers can be achieved.

Preferably, the storage system includes the ability to remotely activate devices located on the container or storage module.

In one embodiment, the storage system includes removable inner storage cells or modules. In a preferred embodiment, these cells or modules can be removed slidably from the container along any side. In another embodiment, these cells or modules can be removed pivotably from the container. In another embodiment, these cells or modules can be removed vertically via lifting mechanisms or apparatus.

In another aspect the present invention provides a modular transport and handling system including:
a container management trailer; and
a container or storage module lifting device.

In a preferred embodiment, a container management trailer exists for the purpose of transporting the container on-site or off-site. In a preferred embodiment, the container management trailer is fitted with the means to relocate the container from the ground, storage level or storage frame onto the trailer without the use of lifting or transport equipment external to that installed on the container management trailer. In a preferred embodiment, the container management trailer is capable of transporting a fully-loaded container on-site or off-site. In a preferred embodiment, the container management trailer is able to relocate the container from or onto the container management trailer onto the ground, storage level or storage frame without the use of lifting and transport equipment external to that installed on the container management trailer.

In a preferred embodiment, a container or storage module lifting device exists for the lifting and/or lowering of containers. In one embodiment, the container or storage module lifting device is able to lift a container from the ground, storage level or storage frame without the use of lifting equipment external to that installed on the container or storage module lifting device. In a preferred embodiment, the container or storage module lifting device is sufficiently designed and capable, such that an appropriate transport truck or trailer is able to be moved under the suspended container or storage module and be subsequently loaded with the container or storage module. In a preferred embodiment, the container or storage module lifting device is sufficiently designed and capable, such that a container or storage module is able to be removed from a transport truck or trailer and allow the truck or trailer to depart unimpeded once unloaded.

In a preferred embodiment, the container or storage module lifting device is designed to be able to stack more than one container or storage module on top of one another, beside one another or in any other relative arrangement.

In a preferred embodiment, the container or storage module lifting device is designed to accommodate a range of surface terrain slopes, undulations, variations, and surface types. In one embodiment adjustment is achieved by an independently-adjustable leg on at least each corner of the container lifting device that is able to level the device for use.

In a preferred embodiment, the container or storage module lifting device's raising and lowering ability is effected by hydraulic, electric, gravitational, or pneumatic means or in any combination of these means.

In a preferred embodiment, the container or storage module lifting device is able to be powered from an external power source or via a power source mounted on or connected to the device.

In a preferred embodiment, the container or storage module lifting device is able to be moved from location to location with built-in wheels or tracks.

In another aspect the present invention provides a modular material cleaning, sorting and treatment system including:
a container having a top, a base, side walls and end walls; and
a cleaning and treatment apparatus housed within the container in an operationally ready state, wherein in a first configuration the side walls and end walls are fixed to form an enclosure around the cleaning, sorting and treatment apparatus for transport of the cleaning, sorting and treatment system, and in a second configuration the end panels and/or side panels and/or roof panels are removable to allow extension of the cleaning, sorting and treatment apparatus, and at least a portion of one of the side walls or end walls or roof is removable to provide access to the cleaning, sorting and treatment apparatus during use, so that the container and the cleaning, sorting and treatment apparatus are transported and installed as a single unit.

In one embodiment, the cleaning, sorting, and treatment apparatus is comprised of integrated screens to remove foreign debris or to sort material by size. In another embodiment, the cleaning, sorting, and treatment apparatus is able to segregate separated materials so as to prevent their re-mixing.

In another embodiment, the cleaning, sorting, and treatment apparatus is comprised of a gravitational-based separation system for the removing of foreign debris or to sort material by weight or size. In another embodiment this may be effected by cyclone or other form of acceleration-utilising forces.

In another embodiment, the cleaning, sorting, and treatment apparatus is comprised of a sorting system for the removing of foreign debris or to sort material by weight, size, colour, defect, shape, or other physical property. This apparatus may be an optical scanner, or other form of scanning technology able to detect such material properties and sort accordingly.

In another embodiment, the cleaning, sorting, and treatment apparatus is comprised of an air blower, vacuum, or other form of sorting system for the removing of foreign debris or to sort material by weight, density, or size.

In another embodiment, the cleaning, sorting, and treatment apparatus is comprised of a system for the treating of material with appropriate products for the protection and longevity of material to be treated, processed, or stored.

In preferred embodiment, the cleaning, sorting, and treatment apparatus is able to be powered by electrical power that is sourced external to the container. In another embodiment, the cleaning, sorting, and treatment apparatus is able to be powered by electrical power generated within the container or adjacent containers.

In a preferred embodiment, the cleaning, sorting, and treatment apparatus is able to store the necessary cleaning, sorting and treatment products and consumables within the container. In another embodiment, the cleaning, sorting, and treatment apparatus is able to source the necessary cleaning, sorting and treatment products and consumables from another source outside the container.

In a preferred embodiment, the cleaning, sorting, and treatment apparatus is able to treat material when being loaded, while material is being stored, while material is being managed, or while material is being out-loaded.

In a preferred embodiment, the cleaning, sorting, and treatment apparatus is able to treat material via gas, tablet, liquid, powder, aerosol, or any combination of these, and is fitted with the appropriate apparatus to effect this treatment means.

In a preferred embodiment, the cleaning, sorting, and treatment apparatus is able to generate the necessary gaseous treatment means on site.

In a preferred embodiment, the cleaning, sorting, and treatment apparatus is able to be supplied with a flow of incoming material to be cleaned, sorted, or treated from a modular and related storage module to the present invention. In another embodiment, the cleaning, sorting, and treatment apparatus is able to be supplied with a flow of incoming material from another external source.

In another aspect the present invention provides a modular material capture, transport and management system including:
a container having a top, a base, side walls and end walls; and
a material capture, transport and management apparatus housed within the container in an operationally ready state, wherein in a first configuration the side walls and end walls are fixed to form an enclosure around the capture, transport and management apparatus for transport of the capture, transport and management system, and in a second configuration the end panels and/or side panels and/or roof panels are removable to allow extension of the capture, transport and management apparatus, and at least a portion of one of the side walls or end walls or roof is removable to provide access to the capture, transport and management apparatus during use, so that the container and the capture, transport and management apparatus are transported and installed as a single unit, or multiple units forming one complete unit where desired.

In a preferred embodiment, the cleaning, sorting, and treatment apparatus is able to accommodate road trucks, off-road trucks, storage devices, other storage modules, trains, or other implements for the receival of material to be stored, treated, transferred, or managed.

In a preferred embodiment, the cleaning, sorting, and treatment apparatus is able to receive material in a manner that enables material to be efficiently and safely received and managed. In one embodiment, the cleaning, sorting, and treatment apparatus is fitted with a protective cover to prevent the ingress of water, dust, or foreign debris into the material flow. In one embodiment, the protective cover is modular and of a fixed nature. In another embodiment, the protective cover is pivotably or slidably attached such that the receival hopper can be enclosed while the system is not in operation.

In another embodiment, the cleaning, sorting, and treatment apparatus is fitted with protective covers to prevent the loss of material while being managed and transported by the system.

In a preferred embodiment, the capture, transport, and management apparatus is comprised of integrated hopper walls that are able to be raised or lowered as required for use or transport, or for the joining of one capture, transport and management module to another or other successive modules.

In a preferred embodiment, the cleaning, sorting, and treatment apparatus is able to be fitted with an integrated ramp for the safe and effective drive on and drive-off of mobile storage apparatus' or trucks delivering to the system. In another embodiment, the cleaning, sorting, and treatment apparatus is able to be fitted with integrated rails for the accommodation of train wagons being unloaded in a drive-through manner.

In another preferred embodiment, the capture, transport, and management apparatus is comprised of removable screens and grids to support the delivery vehicle or mechanism, but allow the material to flow into the capture, transport, and management apparatus.

In another preferred embodiment, the cleaning, sorting, and treatment apparatus is able to be joined to successive other cleaning, sorting and treatment apparatus systems to increase capacity.

In a preferred embodiment, the capture, transport, and management system is able to be fitted with a conveyor, auger, elevator, or pneumatic means or any combination of these means of transporting material from the receival area to the storage area.

In a preferred embodiment, the capture, transport, and management system is able to act as a transfer apparatus between one form of material transport means (being unloaded) in order to load another transport means.

In a preferred embodiment, the capture, transport, and management system is able to be fitted with tracking devices that are able to track, store and transfer the particulars of the load being received or loaded out.

In a preferred embodiment, the capture, transport, and management system is able to weigh the transport apparatus prior to being loaded, while being loaded and after loading is complete. In another preferred embodiment, the capture, transport, and management system is able to weigh the transport apparatus prior to being unloaded, while being unloaded and after unloading is complete.

In another aspect the present invention provides an electronic management application to manage the end to end logistics chain and inter-related processes of the operating and utilisation of the modular storage system and modular cleaning, sorting and treatment system, including:
the inclusion of various application modules and functions; and
a system for the geolocation of storage, and cleaning, sorting and treatment modules; and
and the recording of the status and identification of those modules; and
the trade, electronic ownership transfer, purchase, and sale of units of material being stored, regardless of their location or storage mechanism.

In a preferred embodiment, the electronic management application is able to be utilised on any computer, smart device, or the storage or cleaning, sorting and treatment modules themselves.

In a preferred embodiment, the electronic management application is able to track and record the end-to-end logistics chain and steps contained in the logistics chain, of each storage module or cleaning, sorting and treatment module.

In a preferred embodiment, the electronic management application is able to locate the physical location of each module in real time, or when not connected to the internet the last known location of each module.

In a preferred embodiment, the electronic management application is able to receive, store, manage and transfer the particulars of the material being stored or cleaned, sorted, and treated within the module.

In a preferred embodiment, the electronic management application is able to trace using a unique identifier assigned to the particular module in question. In a preferred embodiment, this unique identifier may be by way of serial number or container registration number. In another embodiment, tracing is by way of Radio Frequency Identification (RFID) tag, or a similarly remotely-readable tag or system. In another embodiment, tracing is by way of barcode or other optical recognition means.

In a preferred embodiment, the electronic management application is able to enter this unique identifier by way of the device's camera, by an external peripheral device or by manual entry.

In a preferred embodiment, the location of the module is question is able to be determined by way of the Global Positioning System (GPS) and related tracking tags and devices. In another embodiment, the location of the module in question is able to be determined by way of entry into the application or by the location of the application host device when the unique identifier is entered.

In a preferred embodiment, the electronic management application is able to remotely operate some functions of the modular storage and modular cleaning, sorting and treatment module. In a preferred embodiment, such functions may include remote locking and unlocking of the container, remote treatment, or application of treatment substances to material stored within the container, remote monitoring of environmental conditions within the container.

In a preferred embodiment, the electronic management application is able to perform related material management functions related to the material being stored, managed, cleaned, sorted, treated, or transported. In one embodiment this may include the ordering of consumables. In another embodiment, the electronic management application may integrate with other production related data to track and correlate production qualities, quantities and other production input and output parameters. In another embodiment, the electronic management application may integrate with data from other equipment used in the production, storage, management, cleaning, sorting, treatment, and transport of material produced.

In a preferred embodiment, the electronic management application may allow the current owner of the material to sell, trade, swap or transfer ownership of the material stored in any module or storage cell to another user. In another embodiment, the electronic management application may allow the end user or buyer of material, to nominate a proposed purchase price or to negotiate other terms of the sale or transfer. In another embodiment, the electronic management application may electronically link buyer and seller in the process of selling, buying, or transferring the title or ownership of material stored in a module.

In a preferred embodiment, the electronic management application may allow any user along the logistics chain (producer, buy, seller, manager, transport provider) to arrange the transport and other management activities of modules.

In a preferred embodiment, the electronic management application may allow users to order supplies, consumables and other necessary inputs or other management materials used at any part of the entire preparation, planting, growing, maintaining, repairing, harvesting, storage and transport logistics chain.

In a preferred embodiment, the electronic management application may be able to communicate with other internal and external members and parts of the logistics chain to aid in planning and efficiency.

In another aspect the present invention provides a modular storage, management and logistics system including:
a container having a top, a base, side walls and end walls; and
a storage frame housed within the container in an operationally ready state, wherein in a first configuration the side walls and end walls are fixed to form an enclosure around the storage frame for transport of the storage system, and in a second configuration the end panels are removable to allow extension of the storage frame, and at least a portion of one of the side walls is removable to provide access to the storage frame during use, so that the container and the storage frame are transported and installed as a single unit, and in a third configuration is fitted with various systems, equipment and other apparatus for the receival, management, storage, treatment and out-loading of material.

In a preferred embodiment, the modular storage, management, and logistics system includes various containers internally fitted with various forms of apparatus for the receival, weighing, classifying, storage, management, treatment, processing, and out-loading of material.

In a preferred embodiment, the modular storage, management, and logistics system includes a container fitted with a bucket elevator, conveyor, auger, or other transport means for the transfer of material from one level to another level. In a preferred embodiment, the modular storage, management, and logistics system includes a multitude of bucket elevators, conveyors, augers, or other transport means for the transfer of material from one level to another level or from one location to another.

In a preferred embodiment, the modular storage, management, and logistics system includes the capability to be expanded or reduced in height, width, length, storage capacity, or material handling rate, through the addition or subtraction of modules.

In a preferred embodiment, the modular storage, management, and logistics system includes a container, or a plurality of containers, fitted with the means for personnel access and the movement of parts and consumables from one level to another. In a preferred embodiment, this may be by stairs and ladders. In another embodiment, this may be by elevators , winding mechanisms or other means for vertical travel.

In a preferred embodiment, the modular storage, management, and logistics system includes a container, or a plurality of containers, that may be arranged in any orientation, plane, elevation, or gradient to suit the application and internal functionality of the container and system.

In a preferred embodiment, the modular storage, management, and logistics system includes a container, or a plurality of containers, fitted with the means for fall prevention. In a preferred embodiment, this may be by the installation of handrails, barriers, and barricades, and slip and trip prevention devices and fall arrest or prevention devices.

In a preferred embodiment, the modular storage, management, and logistics system includes a container, or a plurality of containers, fitted with an internal storage container such that the material is stored with a discreet cell inside each container.

In a preferred embodiment, the modular storage, management, and logistics system includes a container, or a plurality of containers, fitted with an internal storage container such that the material is stored with a discreet cell allowing multiple containers to be joined and allowing material to flow between each.

In a preferred embodiment, the modular storage, management, and logistics system includes a container, or a plurality of containers, fitted with associated valving and flow control mechanisms.

In a preferred embodiment, the modular storage, management, and logistics system includes a container, or a plurality of containers, fitted with conveyors, augers, or other suitable means for the transport of material within the containers and system.

In a preferred embodiment, the modular storage, management, and logistics system includes a container, or a plurality of containers, fitted with electrical and mechanical controls for the management of the overall system and its functions.

In a preferred embodiment, the modular storage, management, and logistics system includes a container, or a plurality of containers, fitted with the means for the unloading of road, water or rail-based transport means with interconnecting means for the transfer of material from the unloading point into the storage containers and system. In one embodiment, the unloading module is able to be covered, or partially covered to protect the system or protect material being unloaded into the system. In another embodiment, the unloading point includes ramps, grating or other devices to facilitate to efficient and effective passage of transport means into, out from and through the unloading point.

In a preferred embodiment, the modular storage, management, and logistics system includes a container, or a plurality of containers, fitted with dust management systems, lighting and other devices to provide a safe working environment.

In a preferred embodiment, the modular storage, management, and logistics system includes a container, or a plurality of containers, fitted with loading out of material from the storage containers and system and into any means of road, water or rail-based transport system. In one embodiment this is via a conveyor, auger, or other means of mechanical transport, or a plurality of conveyors, augers, or other means of transport. In another embodiment, this is via a gravity discharge storage vessel, or plurality of storage vessels, that is able to hold larger quantities of material to facilitate quick loading of transport vessels.

In a preferred embodiment, the modular storage, management, and logistics system includes a container, or a plurality of containers, fitted with scales or other weighing devices for the weighing of the load being in-loaded, out-loaded, stored or managed at the site.

In a preferred embodiment, the modular storage, management, and logistics system includes a container, or a plurality of containers, fitted with means for the fumigation, protection, spraying or other treatment of materials being in-loaded, out-loaded, stored or managed.

### BRIEF DESCRIPTION OF THE DRAWINGS

A preferred embodiment of the invention will now be described with reference to the accompanying drawings, wherein:

FIG. 1 shows one embodiment of the logistics system according to the present invention in which the installation of the logistics system consists of a single module, showing the outer extents of the module, and partial external walls;

FIG. 2 shows an internal view of the logistics system of FIG. 1, in which the side panels have been removed to show a representation of the internal storage modules. FIG. 2 also shows an example of partially-filled storage modules with a direct discharge arrangement at the bottom of the module;

FIG. 3 shows the logistics system of FIG. 1 wherein access panels have been installed into the roof for the loading of materials into the storage modules and providing the ability to fully-seal the internal modules of the module;

FIG. 4 shows the logistics system of FIG. 1 wherein provision for the unloading of the module by auger or other arrangement is made in order to unload the module by mechanical means;

FIG. 5 shows the logistics system of FIG. 2 wherein successive modules are stacked vertically and/or horizontally against one another for the creation of an overall larger storage capacity. FIG. 5 also shows the logistics system of FIG. 2 wherein successive modules are arranged and fitted so as to provide continuous flow vertically from one module to the next, downward;

FIG. 6 shows the logistics system of FIG. 4 wherein successive modules are stacked vertically and/or horizontally against one another for the creation of an overall larger storage capacity. FIG. 6 also shows the logistics system of FIG. 4 wherein successive modules are arranged and fitted so as to provide continuous flow vertically from one module to the next, downward ;

FIG. 7 shows the logistics system of FIG. 2 wherein the logistics module of FIG. 2 has been installed upon a sub base frame to provide access to underneath the module and facilitate load and unloading from transport;

FIG. 8 shows the logistics system of FIG. 2 wherein a module transport trailer is provided for the purpose of moving modules around site. Also shown in FIG. 8 is the provision of a winch arrangement for the mechanical loading and unloading of modules;

FIG. 9 shows the logistics system of FIG. 2 wherein a module transport trailer is being loaded from the elevating frame as outlined in FIG. 7 for the purpose of moving modules around site;

FIG. 10 shows a logistics module that has been fitted with a slewing, luffing and telescoping conveyor for the purposes of loading materials into another storage means. In FIG. 10 the conveyor is shown in its fully collapsed and parked position in such a manner that all components are contained within the module for ease of transport;

FIG. 11 shows the logistics module of FIG. 10 with the conveyor in an extended, heightened and extended operative position;

FIG. 12 shows an arrangement of modules fitted with various internal and external mechanical and electrical features and fittings to form an overall system for the storage and management of grain. As shown in FIG. 12, modules are of various types and purposes and include grain storage modules, elevators, chain conveyors, personnel access and stairways, out-loading augers and conveyor and fumigation and pesticide spray application equipment;

FIG. 13 shows an arrangement of modules fitted with various internal and external mechanical and electrical features and fittings to form an overall system for the storage and management of grain. As shown in FIG. 13, modules are of various types and purposes and include grain storage modules, elevators, chain conveyors, personnel access and stairways, out-loading conveyors, and associated valving for the control of grain flow, and fumigation and pesticide spray application equipment;

FIG. 14 shows an arrangement of modules fitted with various internal and external mechanical and electrical features and fittings to form an overall system for the storage and management of grain. As shown in FIG. 14, modules are of various types and purposes and include grain storage modules, elevators, chain conveyors, personnel access and stairways, out-loading conveyors, and associated valving for the control of grain flow, and fumigation and pesticide spray application equipment. As shown in FIG. 14, modules also exist to facilitate the out-loading of grain from the storage complex via road and or rail and associated control rooms, power supply and storage areas;

FIG. 15 shows an arrangement of modules fitted with various internal and external mechanical and electrical features and fittings to form an overall system for the storage and management of grain. As shown in FIG. 15, modules are of various types and purposes and include grain storage modules, elevators, chain conveyors, personnel access and stairways, out-loading conveyors, and associated valving for the control of grain flow, and fumigation and pesticide spray application equipment. As shown in FIG. 15, modules also exist to facilitate the out-loading of grain from the storage complex via road and or rail and associated fast out-load surge bins, control rooms, power supply and storage areas;

FIG. 16 shows an arrangement of modules fitted with various internal and external mechanical and electrical features and fittings to form an overall system for the storage and management of grain. As shown in FIG. 16, modules are of various types and purposes and include grain storage modules, grain augers, chain conveyors, personnel access and stairways, out-loading conveyors and or augers and associated valving for the control of grain flow, and fumigation and pesticide spray application equipment;

FIG. 17 shows a module acting as in-loading receival hopper for the purpose of receiving grain and subsequent storage into the storage complex or into storage module. The module as shown in FIG. 17 has optional side walls that are retained to increase the volumetric capacity of the hopper arrangement. The hopper module a removable covering roof that provides for weather protection of grain and the hopper internal surfaces and the provision of security when not in use;

FIG. 18 shows the module as shown in FIG. 17 receiving grain that is subsequently loaded onto a stacking conveyor.

FIG. 19 shows the end view of two modules with access means for the unloading of grain by elevating one end to tip the entire module at an angle.

FIG. 20 shows an arrangement of modules fitted with various internal and external mechanical and electrical features and fittings to form an overall system for the storage and management of grain. As shown in FIG. 20, modules are of various types and purposes and include grain storage modules, grain augers, chain conveyors, personnel access and stairways, out-loading conveyors and or augers and associated valving for the control of grain flow, and fumigation and pesticide spray application equipment;

FIG. 21 shows an arrangement of modules fitted with lifting equipment, a single monorail beam or multiple monorail beams for the purpose of hoisting equipment, parts, and other components to and from the upper levels of the silo complex. FIG. 21 also shows the external end doors in the open position allowing the monorail hoist to be used;

FIG. 22 shows an arrangement of modules fitted with a thoroughfare for hoisting and elevating equipment, for the transport of parts, personnel and consumables, and the means by which the elevating equipment is accessed. FIG. 22 also shows dedicated stairways for the use of personnel for travel or escape in the event of an emergency or power failure;

FIG. 23 shows an arrangement of modules fitted with various internal and external mechanical and electrical features and fittings to form an overall system for the storage and management of grain. As shown in FIG. 23, modules are of various types and purposes and include grain storage modules, grain augers, chain conveyors, personnel access and stairways, out-loading conveyors and or augers and associated valving for the control of grain flow, and fumigation and pesticide spray application equipment. As shown in FIG. 23, modules for the storage of grain are aligned in a generally vertical orientation;

FIG. 24 shows an arrangement of modules fitted with various internal and external mechanical and electrical features and fittings to form an overall system for the storage and management of grain. As shown in FIG. 24, modules are of various types and purposes and include grain storage modules, grain augers, chain conveyors, personnel access and stairways, out-loading conveyors and or augers and associated valving for the control of grain flow, and fumigation and pesticide spray application equipment. As shown in FIG. 24, modules for the storage of grain are aligned in a generally horizontal orientation with internal modules to segregate grain types or qualities.

FIG. 25 shows separate storage modules that may be removed from the container of FIG. 24 for the purposes of cleaning, loading, unloading, changing, treatment or as otherwise required.

### DESCRIPTION OF EMBODIMENTS

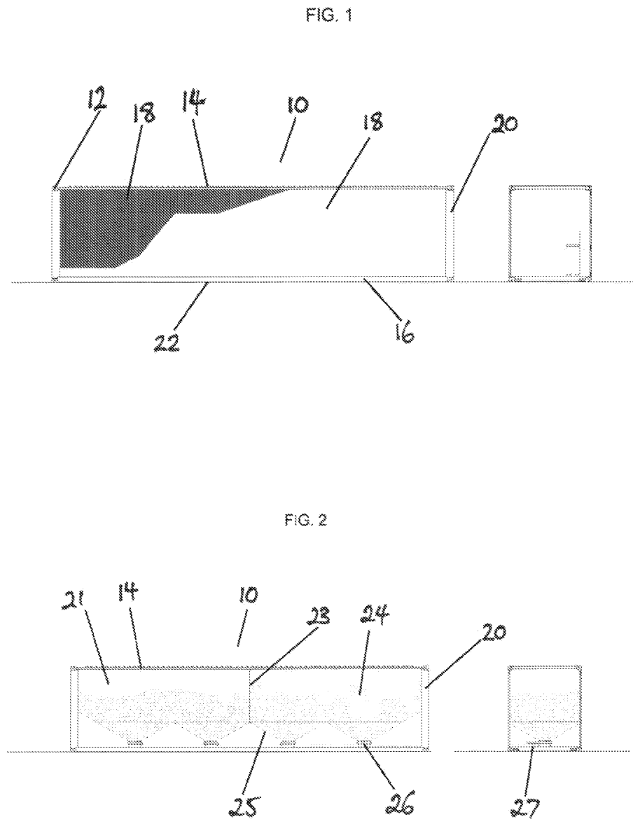

FIGS. 1 to 25 show various embodiments of a modular storage system 10 according to the present invention. The storage system 10 includes a container 12 having a top 14, a base 16, side walls 18 and end walls 20; and
a storage framework 23 housed within the container 12 in an operational ready state, wherein in a first configuration the side walls 18 and end walls 20 are fixed to form an enclosure around the storage framework 23 for transport of the storage system 10, and in a second configuration the end walls 20 are removable to allow access to the storage framework 23, and at least a portion of one of the side, top or bottom walls or surfaces 18 is removable to provide access to the storage framework 23 during use, so that the container 12 and the storage framework 23 are transported and installed as a single unit, and a storage framework wherein separate storage frameworks 59 are housed within the container 12 and are may be transport and installed either with or without each respective separate storage framework 59, and wherein a container 12 may be fitted with various mechanical and/or electrical components for the handling, storage, management and transport of products and interconnect to any other container 12 to form an overall storage complex 100 with various relevant and associated applications and functions.

It is envisioned that other container widths and heights are also applicable. In this system 10, container 12 may be that of a modified high cube, having a height greater than a standard container. The larger height allows for additional room within the container 12 for additional storage volume 21, personnel access under the storage framework 25, or the provision of services and other means of management apparatus.

As shown in FIG. 1, the container 12 may be a standard size (40 ft or 12 m) shipping container or any other appropriate size to accommodate the storage framework 22 whereby the side walls 18, end walls 20, roof 14 and bottom walls 16 are the storage framework 22. The storage system 10 is shipped as a modular unit to an installation and/or usage site. Accordingly, transport costs are limited to the shipping container which is typically not weight dependent.

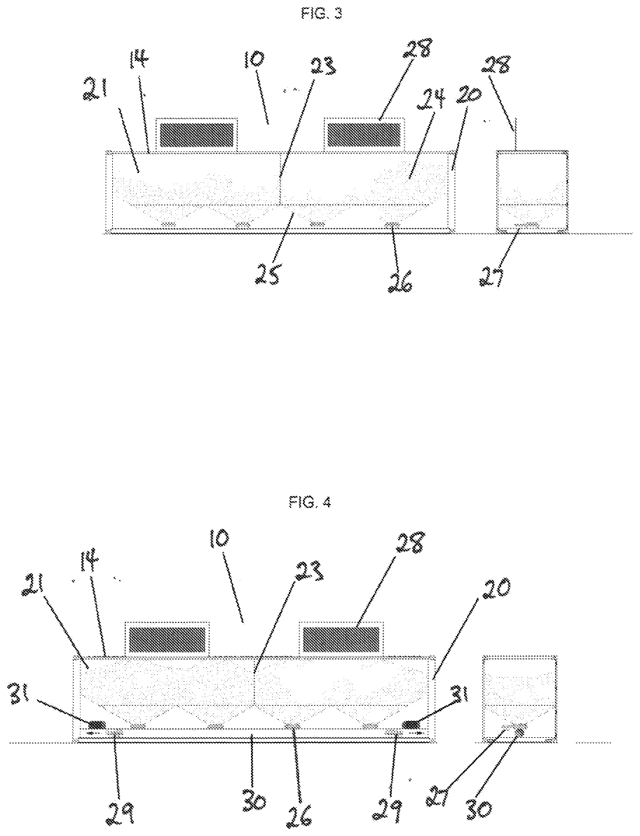

As shown in FIG. 2, the container 12 may be a standard size (40 ft or 12 m) shipping container or any other appropriate size to accommodate an internal storage framework 23 and/or the other mechanical and electrical apparatus appropriate to the application. As shown in FIG. 2. The storage system 10 is shipped as a modular unit to an installation and/or usage site. Accordingly, transport costs are limited to the shipping container which is typically not weight dependent.

As shown in FIG. 2, outflow points 26 are provided on the underside 25 of the storage framework 23 for the purpose of unloading the contents 24 of the various storage modules 21 within the storage system 10. As also shown in FIG. 2 control slides and/or valves 27 that control the flow of material under gravity are fitted.

As shown in FIG. 3, at least one opening 28 is provided in the roof or sides of the container 12 for the purposes of accessing the stored material 24 in the storage framework 23 or for the loading of material 24 into the container, the inspection of material already in the container, the unloading of material from the container, the sampling or treatment of material in the container, or cleaning of the container surfaces and framework 23. The opening 28 may be slidably or pivotably operated to provide access into the container and may be effected by direct operation or activated by a remote control mechanism allowing the operator to remain in a position of superior safety.

As shown in FIG. 4, the modular storage system 10 may be fitted with means for the unloading of material from within the container. As shown in FIG. 4, this may be by the provision of an under-storage transport path 30, which in this example may include an auger 29 powered by an electric motor 31, petrol engine, or hydraulically or pneumatically-powered drive mechanism. As shown in FIG. 4, the control of flow of material from the framework 23 is via under-storage valves and/or slides 26 and fitted with control mechanisms 27 to control the under-storage flow mechanisms 26. As shown in FIG. 4, the modular storage system 10, may be fitted with at least one opening 28 in the roof or sides of the container 12 for the purposes of accessing the stored material 24 in the storage framework 23 or for the recirculation of stored material via the under-storage transport path 30 and in series-wise manner returning to any of the openings 28 in the roof or sides for reloading of material.

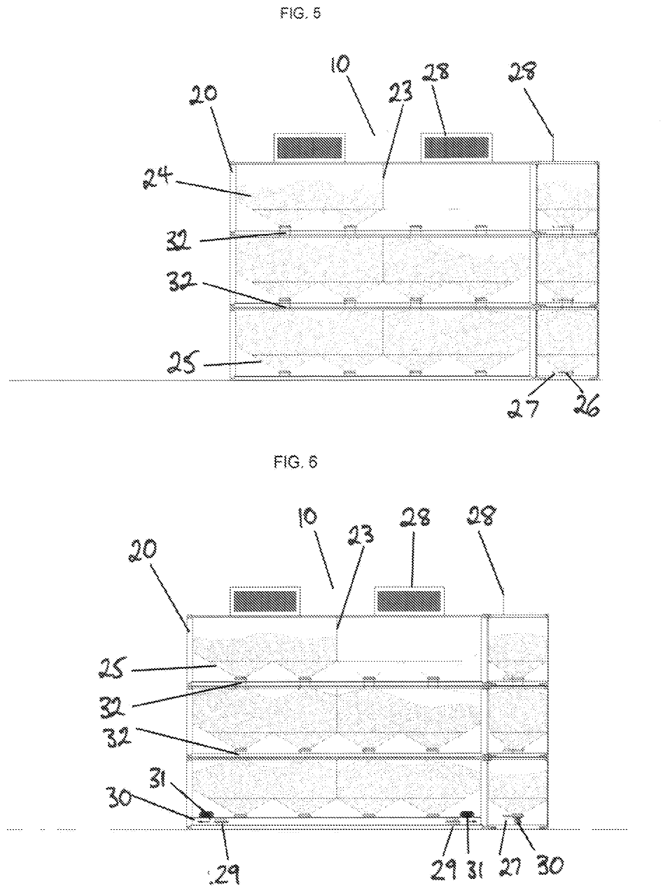

As shown in FIG. 5 and FIG. 6, the modular storage systems 10 may be stacked and arranged on top of one another or beside one another to increase the amount of available storage. When stacked in a vertical manner, modular storages 10 are interconnected to one another by means of interconnecting means 32 allowing the flow of material from one framework 23 to the next. As shown in FIG. 5 and FIG. 6, the control of flow via the interconnecting means 32 is via appropriate slides and/or valving.

As shown in FIG. 6 the bottom-most modules 10 are fitted with an under-storage transport path 30, whereas upper modules are not. Irrespective of location within the stack, it may be preferable in some circumstances for all modules 10 to be fitted with under-storage transport paths.

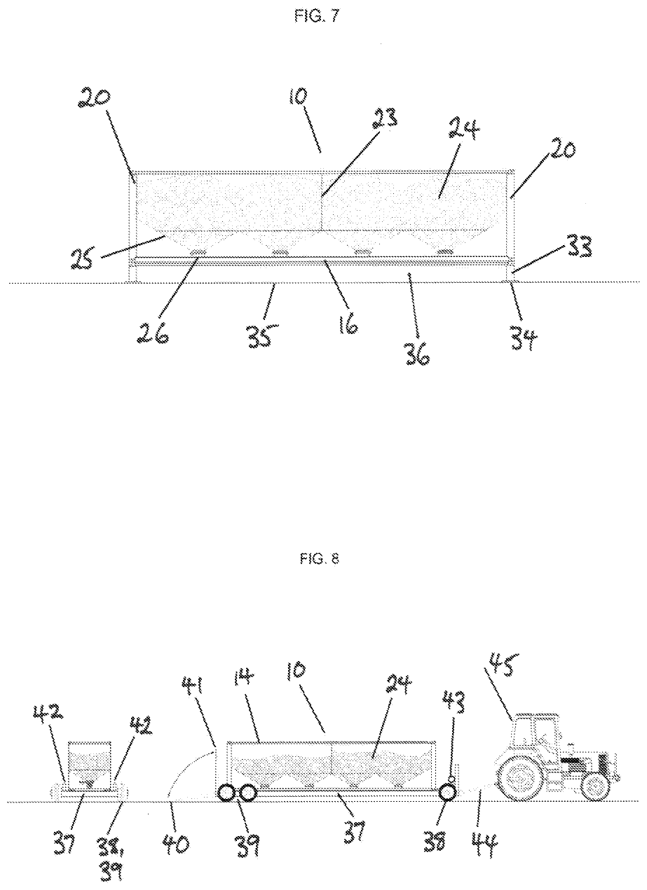

As shown in FIG. 7 is a framework 36 for the raising of the modular storage system 10 to a level above the ground level 35. As shown in Figure, the framework 36 is supported by legs 33 fitted with appropriate ground contact means 34 to reduce the contact pressure with the ground. The raising framework 36 may be supported by legs 33 of fixed length, or of variable and adjustable length to vary the heigh above the ground or to level the structure on uneven or sloping ground. As shown in FIG. 7, the raising framework 36 provides increased under-storage access to under-storage outflow points 26 and other parts of the storage framework 25. As shown in FIG. 7, supportive guide rails run the length of the supportive framework 36 to retain the container in place at the base of the container 16.

As shown in FIG. 7, the storage system 10 may also be installed onto or removed from the supportive frame 36 either in a sliding, vertical or otherwise lifting-type manner.

As shown in FIG. 8, the modular storage system 10 may be transported by specialised transport trailer 37. The transport trailer 37 is fitted with wheels (38-39) or tracks for negotiating varying terrain. The transport trailer is fitted with a loading and unloading ramp (40-41) for access various heights of ground. As shown in FIG. 8, the trailer is also fitted with a haulage mechanism 43 for the loading and unloading of modules onto and from upon the trailer. The transport trailer 37 may also be embodied as a stand-alone vehicle with propulsive power.

As shown in FIG. 8, the transport trailer 37 is connected to a haulage means 45 by an inter-connecting towing arrangement 44 for the physical towing of the trailer. As also shown in FIG. 8, the transport trailer 37 has an integrated guiding framework 42 that prevents the misalignment of the module 10 on the trailer, or the module 10 falling from the confines of the trailer 37.

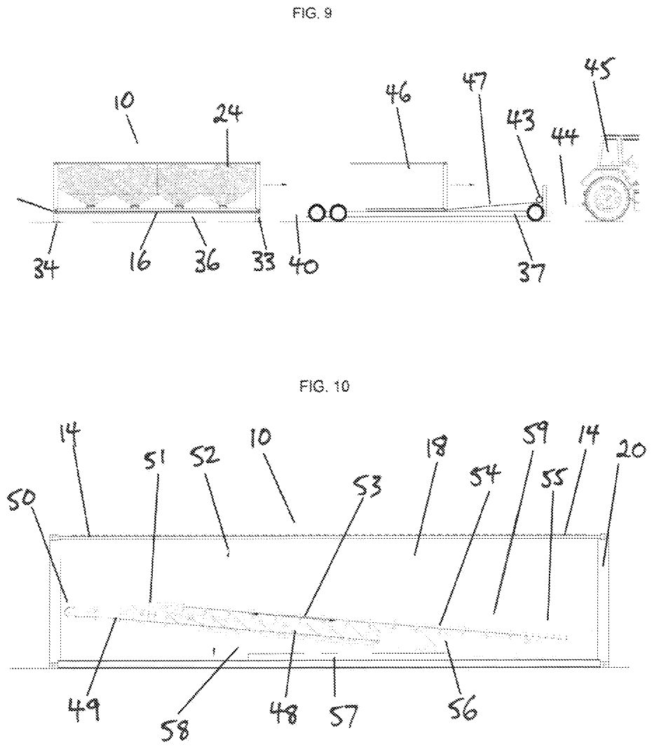

As shown in FIG. 9, the storage system 10 is shown in the example of being installed onto or removed from the supportive frame 36 in a sliding manner in conjunction with the transport trailer 37. As shown in FIG. 9, the module can be drawn onto the trailer 37 from the supportive frame 36 using the haulage apparatus 43. The module may be transferred onto the supportive frame 36 from the trailer 37 with the haulage apparatus applying resultant force to the module in the opposite direction for loading the trailer. In a preferred use of the invention, the trailer 37 is used to move the storage system 10 to a filling site, where the storage system 10 is to be filled with goods to be transported. The storage system 10 may be filled while connected to the trailer 37, or be unloaded from the trailer 37 so that the trailer 37 can undertake other logistical tasks. Once filled, the storage system 10 is the retrieved by the trailer 37 and taken to its destination, at the destination, the full storage system 10 may be deposited and an empty storage system 10 retrieved to eliminate wait times for the trailer 37 at the destination. This is possible due to the interchangeable and reusable nature of the storage system 10.

As shown in FIG. 10, a module 10 and container may be fitted with a means of hauling material. As shown in FIG. 10, the example shown is of a retractable, extending, slewing, luffing and elevating belt conveyor. As shown in FIG. 10, the conveyor is mounted on a sliding base 57 and contains a hopper for loading 55, a larger conveyor 54 cascading onto a smaller and inner conveyor 49 which extends from within the larger conveyor 53. As shown in FIG. 10, the smaller conveyor ultimately has a discharge end 50 for the unloading of material. Elevation is effected by supportive and extendable legs 58.

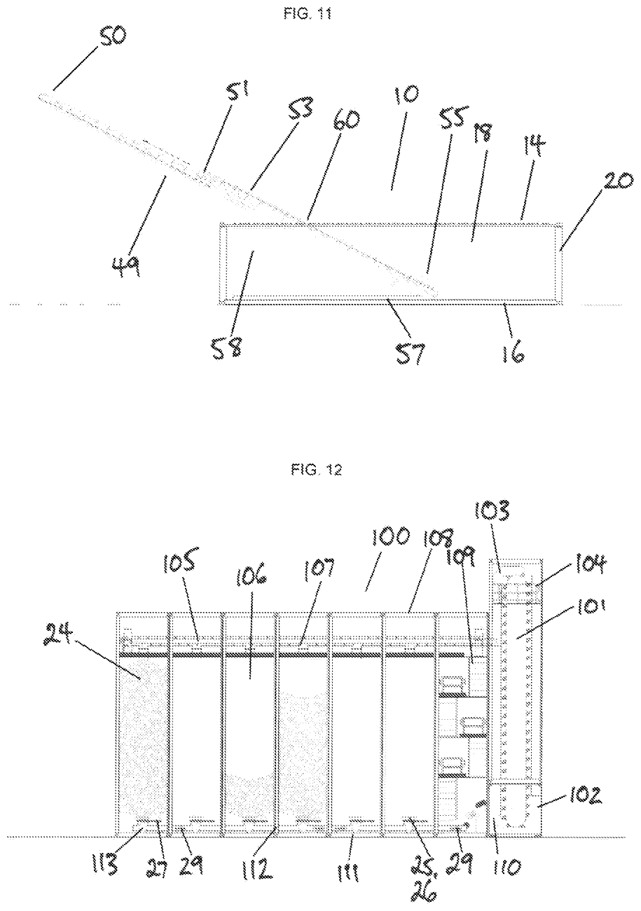

As shown in FIG. 11, the conveyor arrangement as shown in FIG. 10, is in an extended and raised position.

FIGS. 12 to 16 show various embodiments of a modular silo system 100 according to the present invention. The silo system 100 includes modules built from at least one container 108 having a top, a base, side walls and end walls; and
a storage cell 106 housed within the container in an operational ready state, wherein in a first configuration the side walls, end walls and base walls are fixed to form an enclosure around the storage cell 106 for the storage of material, and in a second configuration are fitted with various internal and external mechanical, electrical, structural, and other appropriate apparatus to support and facilitate the intended use.

As shown in FIG. 12, a silo system 100 is arranged through the connection of various modules 108. As shown in FIG. 12, a bucket elevator module 101 exists for the purpose of elevating material from one level to a higher level. The bucket elevator module 101 may be fitted with more than one elevator. At the base of the elevator module 101 is a boot or lower module 102 to accommodate the boot or receival end of the elevator. As shown in FIG. 12, the upper end of the elevator module 101 exists the discharge area 103 and appropriate personnel access walkways, guarding and handrails 104. Also shown in FIG. 12 is a storage module 106 for the storage of material 24, a transport means 105 for the transfer of material from the elevator discharge 103 to the storage module 106. As shown in FIG. 12 are mechanisms 107 for the control of material flow into storage modules 106.

As shown in FIG. 12, the storage modules 108 which form the storage capability of the modular silo system 100, are arranged in a vertical orientation with the base walls and roof of each container being aligned in a vertical plane. As shown in FIG. 12, the storage modules are fitted in this example with an under-silo transport path 29, interconnection points 112 points, and under-storage flow control mechanisms (25, 26, 27) for the unloading of storages to the elevator 110. As also shown in FIG. 12, each storage module contains one discrete storage cell 106.

As shown in FIG. 12, a personnel access module exists 109 complete with stairs, landings, and appropriate guard railing for safe access by personnel to the upper reaches of the silo.

As shown in FIG. 13, a modular silo system 100 is arranged as also represented in FIG. 12 with the addition of an under-silo reclaim conveyor system 117 supporting the storage modules 108 above and leading to the elevator. The flow of material onto the reclaim conveyor 117 is effected by chutes 118 to direct the flow of material and control mechanisms 27 to manage the flow rate of material. In the example shown in FIG. 13, the reclaim conveyor has a drive pulley located at the discharge end of the conveyor 119 leading into the elevator.

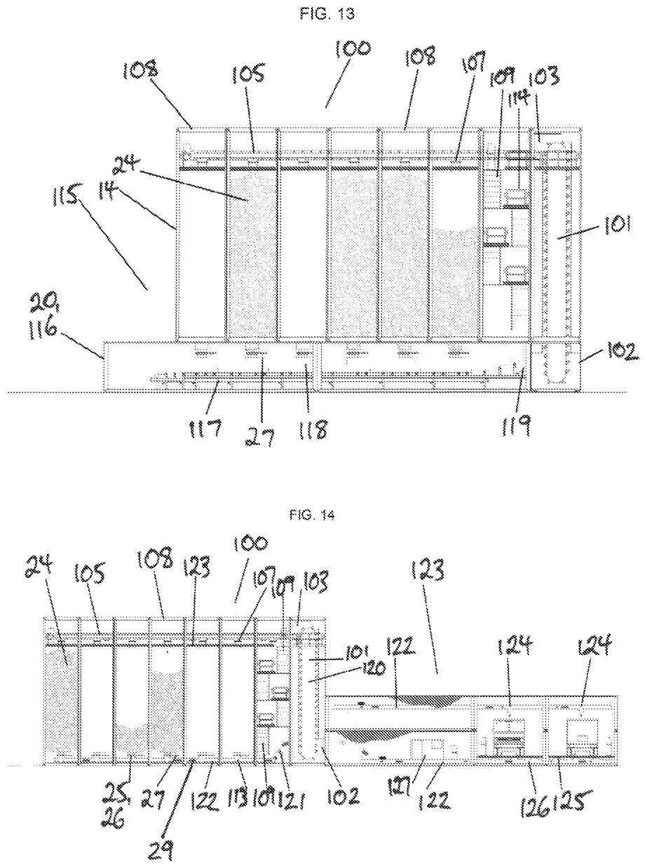

As shown in FIG. 14, is a modular silo system 100 as also represented in FIG. 12 with the addition of vehicle unloading and loading facilities 123. As shown in FIG. 14, a truck, storage module and rail wagon unloading and out loading area 123 is provided with appropriate drive-over hopper and grids 125 and under-floor transport means (122, 126) for the transport of material from the hopper to the elevator 102. Electrical control for the modular silo system 100 is provided by a control station 127 where all functions of the modular silo system may be controlled. As shown in FIG. 14, a chute 120 extends from the top of the elevator 103 to the load out transport means 124 from where road trucks, storage modules 10 and rail transport may all be loaded.

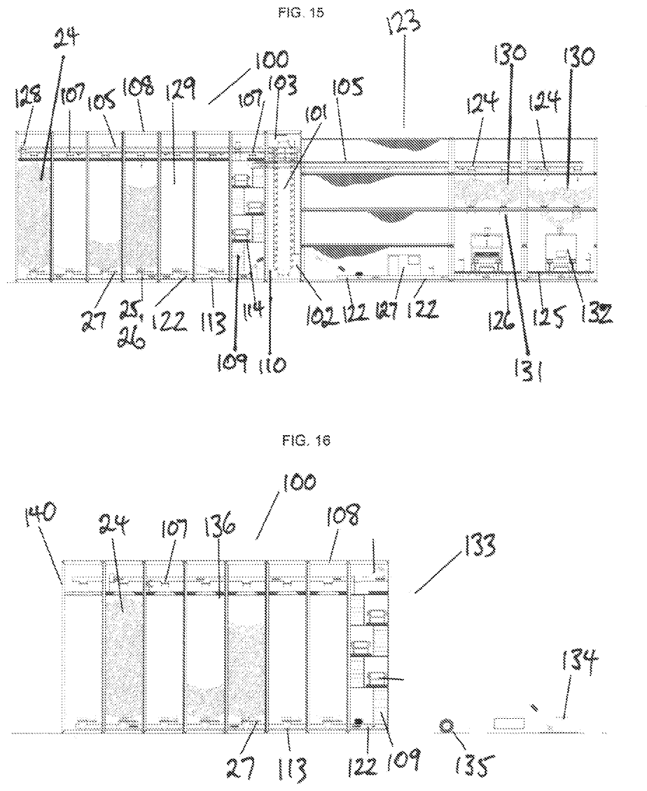

As shown in FIG. 15, is a modular silo system as also shown in FIG. 12, along with the addition of vehicle unloading and loading facilities. As shown in FIG. 15, a truck, storage module and rail wagon unloading and out loading area 123 is provided with appropriate drive-over hopper and grids 125 and under-floor transport means (122, 126) for the transport of material from the hopper to the elevator 102. Electrical control for the modular silo system 100 is provided by a control station 127 where all functions of the modular silo system may be controlled. As shown in FIG. 15, a delivery point 107 transfers material onto a conveyance that extends from the top of the elevator 103 to the load out rapid fill bins 130 for the rapid loading of road trucks 132, storage modules 10 and rail transport via loading chutes 131.

As shown in FIG. 16, is a modular silo system 100 as also represented in FIG. 12 with the addition of a mobile auger 133 for the loading of grain. This is to simplify the overall silo complex and negate the complexity of an elevator as in other figures.

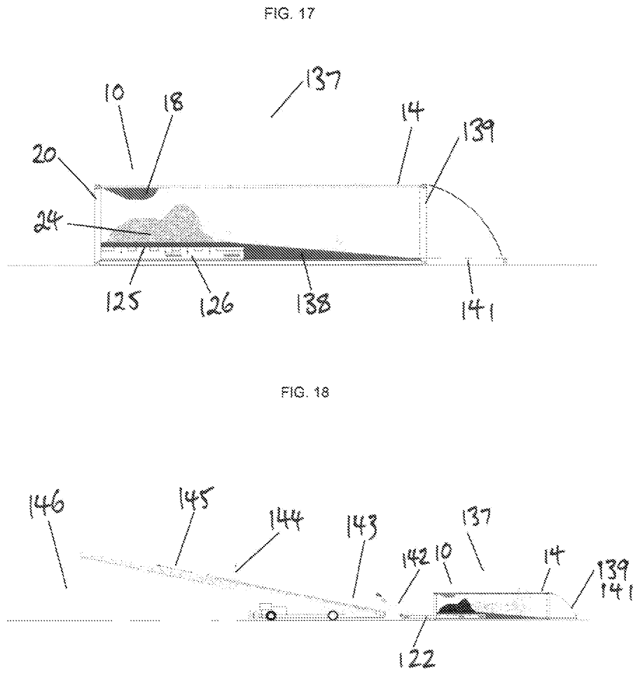

As shown in FIG. 17, is a modular and mobile apparatus for the unloading of trucks and storage modules. A module 10 has optional sidewalls 18, end walls 20 and roof 14 for the retention of material 24 as it is being unloaded from trucks 137 or storage modules. A foldable end wall 139 provides security and an enclosed environment in its vertical position 139, and a ramp when in its horizontal position 141. An internal ramp 138 provides access onto the raise hopper area whereby grids 125 and an under floor transport path is installed 126 for the transport of material to another location. As shown in FIG. 17, the provision of the end walls 20 and side walls 18 allow a larger amount of material to be tipped from trucks and storage modules into a pile so the truck or module can be removed while material is being transported away.

As shown in FIG. 18, the modular and mobile apparatus for the unloading of trucks and storage modules is shown to be unloading onto a mobile stacking conveyor 143. The conveyor is able to extend and retract 145 and raise and lower 144 for the purpose of creating a pile of material 146. The mobile conveyor is loaded from the mobile truck and storage module unloading apparatus by a conveyance (122, 142) of suitable duty.

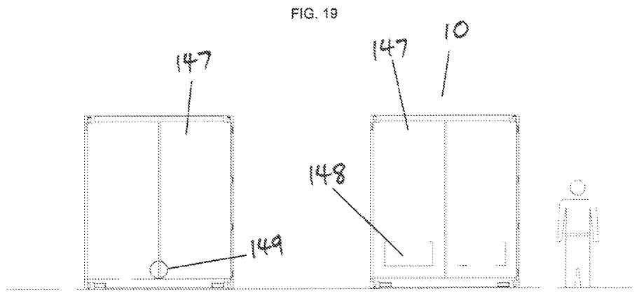

As shown in FIG. 19, is the end-wall of two variations of storage modules 10. In both modules, end walls or doors 147 are in place and shown to be in a closed position. Fitted to the end walls or doors 147 are opening that facilitate to transfer or material from the storage module to elsewhere. This may be by tipping and gravitational means through a hatch or other opening 148, or by the mechanised transfer of material through an appropriate port or opening 149.

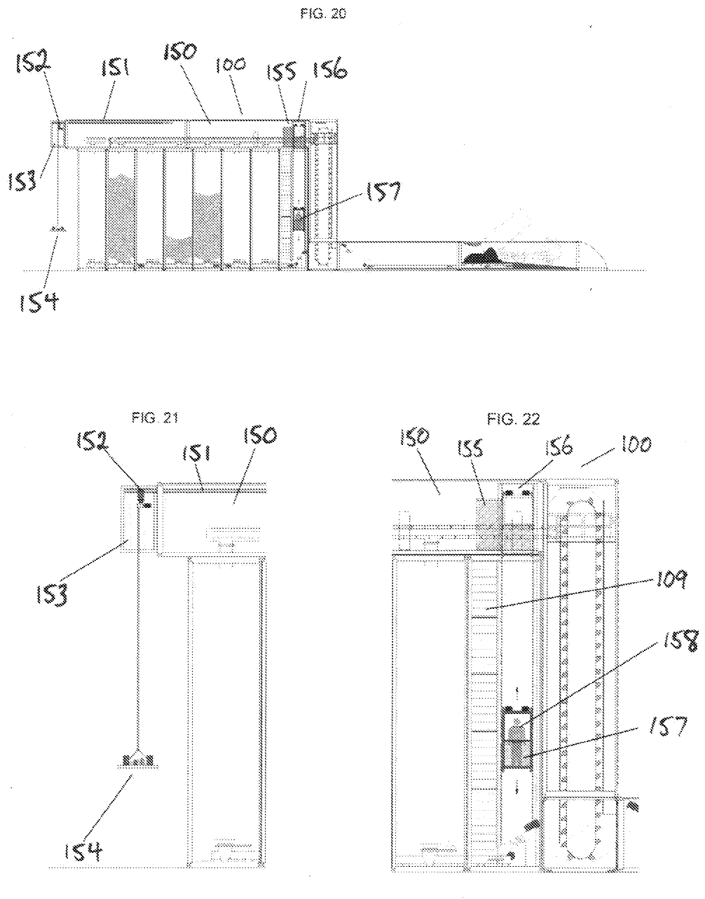

As shown in FIG. 20, is an alternate arrangement of the modular silo system 100 whereby the upper-most containers 150 are arranged horizontally. As shown in FIG. 20, a monorail beam 151 is fitted inside and running along the length of the containers 150 and is used to transport loads 154 along the length of the containers 150, and to and from the outside of the modular silo system 100. Running along the length of the monorail and supporting the load is a monorail trolley 152 and winch arrangement. As shown in FIG. 20, doors 153 at the end of the container 150 can be closed for normal silo operations and opened when needing to provide access for hoisting or lower of materials or parts and components. As shown in FIG. 20, arranged within the uppermost containers is an entry/exit point door 155 for the personnel/parts elevator (156 and 157).

As shown in FIG. 21, is a detailed view of the arrangement outlined also in FIG. 20 showing the upper level container 150, monorail beam 151 inside and protruding from the container, monorail trolley 152 to allow the load to transit along the monorail, end-door in the open position 153, and the load being raised or lowered.

As shown in FIG. 22, is a detailed view of the arrangement outlined also in FIG. 20 showing the upper level container 150, the entry/exit point door 155 for the personnel/parts elevator (156 and 157). As shown in FIG. 22 is a person 158 in transit. Also shown in FIG. 22 are the integrated personnel access stairs 109.

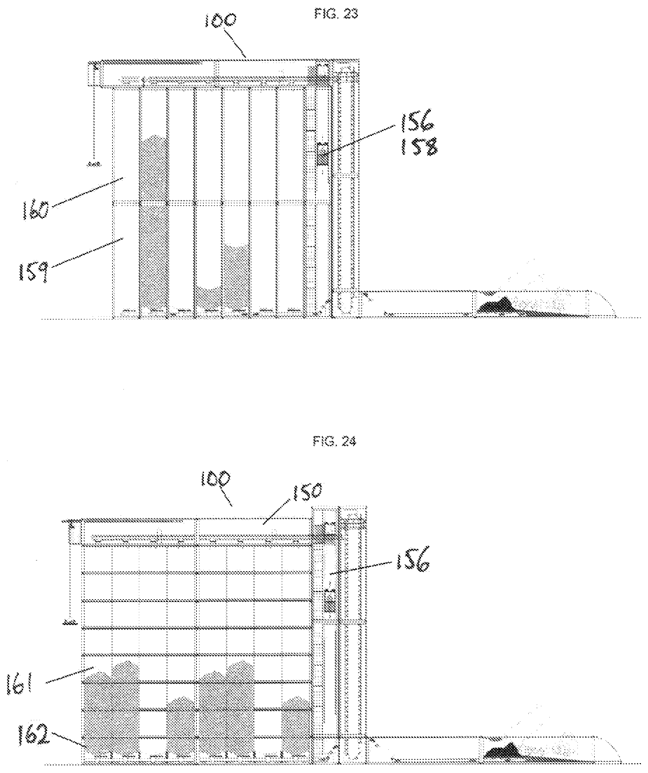

As shown in FIG. 23, is an alternate arrangement of the modular silo system 100 whereby the upper-most containers 150 are arranged horizontally. As shown in FIG. 23, the silo storage containers are of multiple levels arranged end to end 160 and vertically oriented. As shown in FIG. 20, the upper vertical container 160 is supported by a lower base container 159 that is fitted with the requisite under-silo chutes and valving for the recovery of material. As shown in FIG. 23 is an elevator (156 and 158) for the transport of personnel and/or parts and equipment vertically within the modular silo system 100.

As shown in FIG. 24, is an alternate arrangement of the modular silo system 100 whereby the upper-most containers 150 are arranged horizontally. As shown in FIG. 24, the silo storage containers are of multiple levels arranged horizontally 161 and stacked accordingly. As shown in FIG. 24, the upper container(s) 161 is supported by a lower base container 162 that is fitted with the requisite under-silo chutes and valving for the recovery of material. As shown in FIG. 24 is an elevator (156 and 158) for the transport of personnel and/or parts and equipment vertically within the modular silo system 100. As also shown in FIG. 24 is the elevator system 156 provided for the transport of personnel and/or parts and materials.

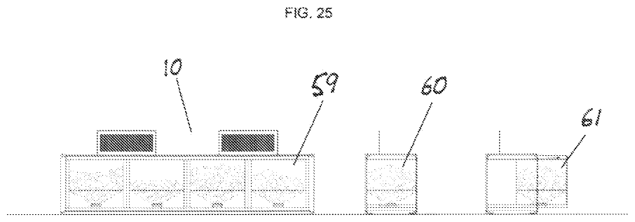

As best seen in FIG. 25, the storage system 10 and container 12 may be fitted with separate storage modules 59 that may be removed from the container 12 for the purposes of cleaning, loading, unloading, changing, treatment or as otherwise required. As shown in FIG. 25, these separate storage modules 59 may be removed altogether or partially according to the intended activity being conducted.

As best shown in FIG. 25, separate storage modules 59 within the container 12, may be in a closed position 60 or in any degree of openness or separation 61 from the container and open in a generally parallel manner with respect to the base of the container.

Although the invention has been described with reference to a specific example, it will be appreciated by those skilled in the art that the invention may be embodied in other forms.

1. A modular logistics system including:
a container having a top, a base, side walls and end walls; and
a storage frame housed within the container in an operationally ready state, wherein in a first configuration the side walls and end walls are fixed to form an enclosure around the storage frame for transport of the storage system, and in a second configuration the end panels are removable to allow extension of the storage frame, and at least a portion of one of the side walls is removable to provide access to the storage frame during use, so that the container and the storage frame are transported and installed as a single unit.

2. The modular logistics system of claim 1, wherein the removable side wall is pivotably attached at the base and configured to open outwardly until generally parallel with the base to form a platform or walkway.

3. The modular logistics system of claim 1 or 2, wherein the removable panel may be slidably attached at or within the base of the container and configured to extend in a parallel manner from within the container to form the platform or walkway.

4. The modular logistics system of any one of claims 1 to 3, wherein the modular storage system includes a plurality of storage frames, each frame being housed in its respective container in an operationally ready state, and each modular storage system being connectable to an adjacent modular storage system to form a continuous run.

5. The modular logistics system of any one of claims 1 to 4, wherein a plurality of storage modules and frames may be housed in a single container in an operationally ready state to allow for the transport, installation and use of more than one storage line in total.

6. The modular logistics system of any one of claims 1 to 5, wherein the modular storage systems may be connectable in multiple configurations including at least a horizontally straight and level configuration suitable for a level terrain, a vertical and/or horizontal configuration to negotiate an undulating terrain, or a horizontally straight and curved configuration to negotiate turns.

7. The modular logistics system of any one of claims 1 to 6, wherein the walls of the container may provide suitable storage for a material to be transported within the container.

8. The modular logistics system of any one of claims 1 to 7, wherein the container may house an inner storage structure made from one or more of steel, plastic, polymer, fabric, and textile,
wherein the inner storage structure may substantially conform to the outer walls of the container.

9. The modular logistics system of claim 8, wherein the container and/or inner storage structure within may be accessed by at least one cover or opening in the roof, any side or end wall of the container,
wherein the cover is operated by being screwed into and away from the container and/or inner storage structure.

10. The modular logistics system of claim 8 or 9, wherein the inner storage structure may have access provided separate to that of the access provided to the container.

11. The modular logistics system of any one of claims 8 to 10, wherein at an access point to the container or the inner storage structure, a protective hood or shroud is provided for securing and protecting material transfer into or out of the container or the inner storage structure from contaminants, weather ingress, material loss, and/or for the control of dust.

12. The modular logistics system of any one of claims 1 to 11, wherein loading of material into the container may be effected by mechanical means, gravitational means, or a combination of both mechanical and gravitational means.

13. The modular logistics system of any one of claims 1 to 12, wherein the container is fitted with ventilation devices to allow gasses, dust, or excessive heat to be dissipated to outside the container, but prevent the ingress of moisture, dust, pests, or other unwanted contaminants.

14. The modular logistics system of any one of claims 1 to 13, wherein the container may be unloaded using any one or more of an auger, a conveyor, compressed air, and suction.

15. The modular logistics system of any one of claims 1 to 14, wherein the container or the storage modules housed within the container, is provided with weighing means to weigh the contents of the container.

16. The modular logistics system of any one of claims 1 to 15, wherein the container is fitted with fixtures and features such as chains, hooks, slings, lifting points, fork tine openings and conventional container securing mechanisms to facilitate transport using as an intermodal shipping container.

17. The modular logistics system of any one of claims 1 to 16, wherein the storage system includes piped services housed within the container, wherein the piped services include any one or more of compressed air lines and/or hoses; fresh, fire and waste-water reticulation pipes and hoses, as well as lines for the transportation and reticulation of liquid or gasses, preferably pesticides or fertilisers.

18. The modular logistics system of any one of claims 1 to 17, wherein the storage system includes a fire protection system fitted within the container,
wherein the fire protection system includes a oxygen-displacing system reticulated through, within or along the container, and to successive containers.

19. The modular logistics system of any one of claims 1 to 18, wherein the container includes means for the sampling of material stored within the container, from a position inside and/or outside the container.

20. The modular logistics system of any one of claims 1 to 19, wherein the container includes attachment means for connecting to an adjacent container to form a continuous storage run,
wherein the attachment means includes a mounting plate to seal the containers from the outside environment.

21. The modular logistics system of any one of claims 1 to 20, wherein the container is configured to securely attach to a ground footing,
wherein the ground footing includes a concrete footing with a securing mechanism to secure the container relative to the concrete footing.

29. A modular transport and handling system including:
a container management vehicle or trailer; and
a container or storage module lifting device,
wherein the container management trailer allows transportation of the container and is fitted with a lifting means to relocate the container to and from a ground, a storage level or a storage frame onto the management trailer without the use of lifting or transport equipment external to that installed on the container management trailer, and
wherein the container or storage module lifting device allows lifting and/or lowering of containers to and from a transport truck, the container or storage module lifting device allows the transport truck or trailer to be moved under container or storage module lifting device and be subsequently loaded or unloaded lowering or lifting the container or storage module,
wherein the container or storage module lifting device has built-in wheels or tracks to be movable from a first location to a second location.

30. A modular material cleaning, sorting and treatment system including:
a container having a top, a base, side walls and end walls; and
a cleaning and treatment apparatus housed within the container in an operationally ready state, wherein in a first configuration the side walls and end walls are fixed to form an enclosure around the cleaning, sorting and treatment apparatus for transport of the cleaning, sorting and treatment system, and in a second configuration the end panels and/or side panels and/or roof panels are removable to allow extension of the cleaning, sorting and treatment apparatus, and at least a portion of one of the side walls or end walls or roof is removable to provide access to the cleaning, sorting and treatment apparatus during use, so that the container and the cleaning, sorting and treatment apparatus are transported and installed as a single unit.

31. The modular material cleaning, sorting, and treatment system of claim 30, wherein the cleaning, sorting, and treatment apparatus is comprised of integrated screens to remove foreign debris or to sort material by size.

32. The modular material cleaning, sorting, and treatment system of claim 30 or 31, wherein the cleaning, sorting, and treatment apparatus is comprised of a gravitational-based separation system for the removing of foreign debris or to sort material by weight or size.

33. The modular material cleaning, sorting, and treatment system of any one of claims 30 to 32, wherein the cleaning, sorting, and treatment apparatus includes a sorting system for the removing of foreign debris or to sort material by a material property selected from weight, size, colour, defect, and shape,
wherein the apparatus includes an optical scanner able to detect such material properties.

34. The modular material cleaning, sorting, and treatment system of any one of claims 30 to 33, wherein the cleaning, sorting, and treatment apparatus includes an air blower, vacuum, for the removing of foreign debris or to sort material by weight, density, or size.

35. A modular material capture, transport and management system including:
a container having a top, a base, side walls and end walls; and
a material capture, transport and management apparatus housed within the container in an operationally ready state, wherein in a first configuration the side walls and end walls are fixed to form an enclosure around the capture, transport and management apparatus for transport of the capture, transport and management system, and in a second configuration the end panels and/or side panels and/or roof panels are removable to allow extension of the capture, transport and management apparatus, and at least a portion of one of the side walls or end walls or roof is removable to provide access to the capture, transport and management apparatus during use, so that the container and the capture, transport and management apparatus are transported and installed as a single unit, or multiple units forming one complete unit where desired.

36. The modular material capture, transport and management system of claim 35, wherein the cleaning, sorting, and treatment apparatus is able to accommodate road trucks, off-road trucks, storage devices, other storage modules, trains, or other implements for the receival of material to be stored, treated, transferred, or managed.

37. The modular material capture, transport and management system of claim 35 or 36, wherein the cleaning, sorting, and treatment apparatus is fitted with a protective cover to prevent the ingress of water, dust, or foreign debris into the material flow, or to prevent the loss of material while being managed and transported by the system,
wherein the protective cover is modular and pivotably or slidably attached such that the receival hopper can be enclosed while the system is not in operation.

38. The modular material capture, transport and management system of any one of claims 35 to 37, wherein the capture, transport, and management apparatus includes integrated hopper walls that are able to be raised or lowered as required for use or transport, or for the joining of one capture, transport and management module to another or other successive modules.

39. The modular material capture, transport and management system of any one of claims 35 to 38, wherein the cleaning, sorting, and treatment apparatus is able to be fitted with an integrated ramp for the safe and effective drive on and drive-off of mobile storage apparatus' or trucks delivering to the system.

40. The modular material capture, transport and management system of any one of claims 35 to 39, wherein the capture, transport, and management apparatus includes removable screens and grids to support the delivery vehicle or mechanism, but allow the material to flow into the capture, transport, and management apparatus.

41. A modular storage, management and logistics system including:
a container having a top, a base, side walls and end walls; and
a storage frame housed within the container in an operationally ready state, wherein in a first configuration the side walls and end walls are fixed to form an enclosure around the storage frame for transport of the storage system, and in a second configuration the end panels are removable to allow extension of the storage frame, and at least a portion of one of the side walls is removable to provide access to the storage frame during use, so that the container and the storage frame are transported and installed as a single unit, and in a third configuration is fitted with various systems, equipment and other apparatus for the receival, management, storage, treatment and out-loading of material.

42. The modular storage, management and logistics system of claim 41, wherein the modular storage, management, and logistics system includes a container fitted with a bucket elevator, conveyor, auger, or other transport means for the transfer of material from one level to another level.

43. The modular storage, management and logistics system of claim 41 or 42, wherein the modular storage, management, and logistics system includes a container, or a plurality of containers, fitted with a fall prevention means,
wherein the fall prevention means include handrails, barriers, barricades, slip and trip prevention devices, and/or fall arrest or prevention devices.

44. The modular storage, management and logistics system of any one of claims 41 to 43, wherein the modular storage, management, and logistics system includes a container, or a plurality of containers, fitted with an internal storage container such that the material is stored with a discrete cell inside each container.

45. The modular storage, management and logistics system of any one of claims 41 to 44, wherein the modular storage, management, and logistics system includes a container, or a plurality of containers, fitted with an internal storage container such that the material is stored with a discrete cell allowing multiple containers to be joined and allowing material to flow between each.

46. The modular storage, management and logistics system of any one of claims 41 to 45, wherein the modular storage, management, and logistics system includes a container, or a plurality of containers, fitted with associated valving and flow control mechanisms.

47. The modular storage, management and logistics system of any one of claims 41 to 46, wherein the modular storage, management, and logistics system includes a container, or a plurality of containers, fitted with conveyors, augers, or other suitable means for the transport of material within the containers and system.

48. The modular storage, management and logistics system of any one of claims 41 to 47, wherein the modular storage, management, and logistics system includes a container, or a plurality of containers, fitted with electrical and mechanical controls for the management of the overall system and its functions.

49. The modular storage, management and logistics system of any one of claims 41 to 48, wherein the modular storage, management, and logistics system includes a container, or a plurality of containers, fitted with the means for the unloading of road, water or rail-based transport means with interconnecting means for the transfer of material from the unloading point into the storage containers and system.

50. The modular storage, management and logistics system of any one of claims 41 to 49, wherein the modular storage, management, and logistics system includes a container, or a plurality of containers, fitted with dust management systems, lighting and other devices to provide a safe working environment.

51. The modular storage, management and logistics system of any one of claims 41 to 50, wherein the modular storage, management, and logistics system includes a container, or a plurality of containers, fitted with loading out of material from the storage containers and system and into any means of road, water or rail-based transport system.

52. The modular storage, management and logistics system of any one of claims 41 to 51, wherein the modular storage, management, and logistics system includes a container, or a plurality of containers, fitted with scales or other weighing devices for the weighing of the load being in-loaded, out-loaded, stored or managed at the site.

53. The modular storage, management and logistics system of any one of claims 41 to 52, wherein the modular storage, management, and logistics system includes a container, or a plurality of containers, fitted with means for the fumigation, protection, spraying or other treatment of materials being in-loaded, out-loaded, stored or managed.
